(19) United States
(12) Patent Application Publication
(10) Pub. No.: US 2013/0025276 A1
(43) Pub. Date: Jan. 31, 2013

(54) METHOD AND DEVICE FOR PRODUCING A CARBON DIOXIDE-RICH GAS MIXTURE, METHOD AND DEVICE FOR IMPROVED OIL RECOVERY AND CORRESPONDING USE OF A GAS ENGINE

(71) Applicants: Robert ADLER, Gerasdorf (AT); Alexander Alekseev, Wolfratshausen (DE); Andreas Opfermann, Grafelfing (DE)

(72) Inventors: Robert ADLER, Gerasdorf (AT); Alexander Alekseev, Wolfratshausen (DE); Andreas Opfermann, Grafelfing (DE)

(73) Assignee: LINDE AKTIENGESELLSCHAFT, Munchen (DE)

(21) Appl. No.: 13/560,281

(22) Filed: Jul. 27, 2012

(30) Foreign Application Priority Data
Jul. 28, 2011 (DE) 10 2011 108 854.0

(51) Int. Cl. F01N 3/00; F02B 37/00; F02M 25/07

(52) U.S. Cl. 60/605.2; 60/273; 60/278

(57) ABSTRACT

The invention relates to a method for producing a carbon dioxide-rich gas mixture (44) wherein a hydrocarbon-containing fuel (21) is burned in a combustion chamber of a gas engine (10) in a gas atmosphere, and the exhaust gas (14) of the gas engine (10) is processed into the carbon dioxide-rich gas mixture (44). The gas atmosphere in the combustion chamber has an oxygen content (33) that corresponds to 0.9 to 1.1 times the amount of oxygen required for complete combustion of the hydrocarbon-containing fuel (21), and the gas atmosphere has a volumetric ratio of nitrogen to oxygen (33) in that is less than 3.5 to 1. The invention also relates to an apparatus for producing the carbon dioxide-rich gas mixture (44), and a method and apparatus for enhanced oil recovery using the method and apparatus for producing the carbon dioxide-rich gas mixture (44).

### SUMMARY OF THE INVENTION

The invention relates to a method and apparatus for producing a carbon dioxide-rich gas mixture, a method and apparatus for improved oil recovery, and the corresponding use of a gas engine.

Carbon dioxide and carbon dioxide-nitrogen mixtures, such as are known, for example, from DE 10 2009 038 444 A1 (US 2010/096146) and DE 10 2009 038 445 A1 (US 2010/101808), are used for so-called enhanced oil recovery (EOR) within the framework of tertiary petroleum extraction. In this case, to recover even dense, viscous petroleum fractions and/or those held by capillary action within layers of rock or soil, fluids under pressure are forced into and/or around the corresponding deposits via suitable pipe lines. Carbon dioxide mixes with the petroleum to be extracted and reduces its viscosity. This facilitates transport of the petroleum.

A similar application of carbon dioxide involves the extraction of underground or mine gases such as so-called coal bed methane (CBM), adsorptively bound methane in coal deposits with more than 90% methane content. In this application, carbon dioxide is likewise forced into the corresponding deposits within the framework of so-called enhanced CBM recovery. Carbon dioxide can also be used accordingly for improved exploitation of oil shales and oil sands.

For the indicated applications, gas mixtures with a relatively high proportion of carbon dioxide from 50 to 80 mol % are required. In addition, the gas mixtures preferably contain as small a proportion as possible of impurities such as argon, oxygen, hydrocarbons, water, carbon monoxide as well as nitrogen oxides and sulfur oxides. In particular, gas mixtures having a low oxygen content are desirable in these applications. The maximum allowable oxygen concentration is generally given as 100 ppm, often also only 10 ppm. Hydrocarbons that are contained in corresponding gas mixtures are, of course, less disadvantageous.

The indicated high carbon dioxide concentrations can, for example, be achieved using the so-called oxyfuel method that is known from power plant engineering and that was originally developed for carbon dioxide production. In the oxyfuel method, fuels such as coal, natural gas or other hydrocarbons are burned with almost pure oxygen (oxygen concentration >95 mol %) in a water-tube boiler. After cooling and separating the water, the flue gas consists primarily of carbon dioxide (>85%). Flue gas return is an important component of this method because it can reduce the otherwise overly high combustion temperature in the boiler. Combustion must take place in the oxyfuel method with a slight oxygen excess so that the residual oxygen concentration in the flue gas is in the range from 1 to 5 mol %, therefore far above the aforementioned requirements.

Oxyfuel methods can also be implemented on the basis of gas turbines with flue gas return (for example, in the so-called Matiant method). To date, however, no plants of this type have been built. This is due to the fact that, among other things, combustion in a gas turbine of this type takes place with a relatively large oxygen excess. The oxygen concentration in the flue gas is >10 mol %. Since half of the oxygen used remains unused and is lost with the flue gas, the method is altogether uneconomical.

As mentioned, the oxygen concentrations that are required within the framework of these applications cannot be maintained by oxyfuel methods so that oxygen must be separated in a complex manner. Oxyfuel methods are very complex in their technical implementation and require boilers for oxygen combustion and a steam circuit with corresponding steam turbines, condensers and pumps. Flue gas treatment with corresponding exhaust gas return is likewise complex. Oxyfuel plants are therefore relatively expensive, large and immobile.

There is therefore a demand for simple and economical production of corresponding carbon dioxide-rich gas mixtures, especially for direct use in enhanced oil recovery.

Against this background, this invention proposes a method and apparatus for producing a carbon dioxide-rich gas mixture, a method and apparatus for improved oil recovery, as well as the corresponding use of a gas engine according to the features described herein.

Upon further study of the specification and appended claims, other aspects and advantages of the invention will become apparent.

According to the invention, a method for producing a carbon dioxide-rich gas mixture is provided in which a hydrocarbon-containing fuel is burned in a combustion chamber of a gas engine in a gas atmosphere, and the resultant exhaust gas of the gas engine is processed into the carbon dioxide-rich gas mixture. In the combustion chamber of the gas engine, there is a gas atmosphere that has or contains oxygen in an amount that corresponds to 0.9 to 1.1 times the oxygen that is required for complete combustion of the hydrocarbon-containing fuel. According to the invention, the volumetric ratio of nitrogen to oxygen in the gas atmosphere is less than 3.5:1. These ratios encompass especially also gas atmospheres in which there is no nitrogen, as presented in detail below.

Because the gas atmosphere has oxygen in the indicated amounts, a stoichiometric, a slightly superstoichiometric or a slightly substoichiometric combustion of the fuel can be effected. Corresponding combustion conditions are well-known from engine technology and are labeled so-called “rich” (for a fuel excess) or “lean” (for an oxygen or air excess) operation. In particular, a substoichiometric combustion, i.e., an excess of fuel relative to oxygen, in which the gas atmosphere contains oxygen in an amount that corresponds to 0.9 to 1.0 times the oxygen that is required for complete combustion of the hydrocarbon-containing fuel, can be advantageous in the applications under discussion here. In this connection, incomplete combustion takes place, as a result of which hydrocarbons remain in the exhaust gas. For the discussed applications, specifically, for example, enhanced petroleum recovery or enhanced gas exploitation, hydrocarbons in the gas can, however, be regarded as rather nonproblematic, as mentioned.

Optionally, small (residual) oxygen contents that are present in the exhaust gas and that, for example, can also originate from a slightly superstoichiometric combustion, can be easily removed in corresponding exhaust gas treatment and/or gas purification units that are explained in detail below. Therefore, the invention is not limited to exactly stoichiometric ratios, but can be flexibly adapted to changing fuel or fresh gas compositions. In particular, operation in the slightly substoichiometric range, i.e., an excess of fuel relative to oxygen, therefore allows a safety buffer to be made available so that a temporary increase in oxygen concentration need not result directly in an increase of the oxygen content of the exhaust gas, and thus of the carbon dioxide-rich gas mixture that is produced.

The invention is based on the finding that the combustion of gaseous or liquid hydrocarbons, called “hydrocarbon-containing fuels” within the framework of this invention, can be implemented in gas engines, in contrast to oxyfuel methods, with only minimum oxygen excess or with an oxygen deficiency. As mentioned, this makes it possible to keep the oxygen concentration low in the exhaust gas and thus in the initial mixture that is subsequently processed into the carbon dioxide-rich gas mixture. As a result, optionally required oxygen removal for this reason can be done either in an energy-favorable or cost-favorable manner, or is not necessary because the correspondingly required maximum oxygen contents are not exceeded.

In contrast to the above-explained so-called oxyfuel systems, gas engines are compact, efficient and economical. A corresponding overall system can therefore be economically produced, be transportable, and be efficiently operated. Advantageously, the nitrogen concentration in the gas mixture that is obtained by the method can be controlled by the amount and concentration of the oxygen in the oxygen flow that is supplied to the engine in the form of a fresh gas.

The gas atmosphere that is present in the engine generally comprises variable portions of fuel, oxygen, and nitrogen, and if exhaust gas return, for example, via a turbocharger, takes place, optionally carbon dioxide and water. Within the framework of this application, “oxygen” and “nitrogen” are defined as gaseous oxygen and nitrogen respectively. According to the invention, in addition to the stoichiometric ratios that have already been discussed, the nitrogen content is especially important since it directly influences the nitrogen content in the product.

The nitrogen/oxygen volumetric ratio in normal air, and thus based on the standard volume of 22.4 L/mol roughly also the molar ratio, is approximately 3.7:1 (78.084 mol % of nitrogen, 20.942 mol % of oxygen). If fuel is burned stoichiometrically with normal fresh air, the gas atmosphere in the gas engine in addition to stoichiometric portions of fuel and oxygen therefore also comprises nitrogen and oxygen in a ratio of roughly 3.7:1.

If, in addition, exhaust gas is supplied, for example, via a turbocharger, the nitrogen/oxygen ratio increases since the exhaust gas, aside from the nitrogen oxides that have formed, has at least 78% nitrogen, but rather less oxygen. The nitrogen/oxygen ratio of the exhaust gas is therefore at least 3.7 to 1.

In order to achieve a carbon dioxide content that has been increased relative to these combustion conditions, conditions in an internal combustion engine must therefore be created under which nitrogen and oxygen are present in a ratio of less than 3.7:1, most generally less than 3.5:1. This corresponds to combustion with air that has already been slightly depleted of nitrogen or slightly enriched with oxygen. If, for example, methane is stoichiometrically burned in a gas atmosphere with a nitrogen/oxygen ratio of 3.5:1, the combustion can be balanced by the following equation:

CH₄+2O₂+7N₂→CO₂+2H₂O+7N₂

Advantageously, the volumetric ratio of nitrogen to oxygen in the gas atmosphere is less than 3:1, less than 2:1, less than 1:1, less than 1:2, less than 1:3, less than 1:4, less than 1:5 or less than 1:10. In this case, the volumetric ratios can be flexibly adapted to the respectively existing requirements with respect to the carbon dioxide content of the carbon dioxide-rich gas mixture so that only the degree of depletion and enrichment with respect to oxygen or nitrogen that is economically useful need be made available.

For very high purity requirements, a nitrogen-free gas atmosphere can also be produced. Here, of course, the term “nitrogen-free” also encompasses small residual nitrogen contents, for example less than 5%.

Advantageously, making available the gas atmosphere encompasses the return of at least one part of the exhaust gas to the combustion chamber so that the gas atmosphere in the combustion chamber is formed in one part from so-called fresh gas, therefore gas that is externally supplied and, for example, originates from an oxygen enrichment system, and in another part from exhaust gas. The fuel can likewise constitute a part of the gas atmosphere, especially when it is present in gaseous form. Especially advantageously in this connection, known methods of engine technology, for example corresponding turbochargers, can be used that ensure especially efficient and economical operation.

Exhaust gas treatment steps that can be connected downstream from the combustion advantageously comprise cooling (e.g., in indirect heat exchange in a heat exchanger), precipitation of water (e.g., by cooling in a heat exchanger to condense water vapor, and removing condensate in a gas-liquid separator), filtration and/or separation of unwanted components (e.g., removal of solid particles, sulfur oxides and other components in a scrubber), as is further discussed below within the framework of the apparatus according to the invention. In this way, carbon dioxide-rich gas mixtures with any desired purity can be produced.

Advantageously, by means of a corresponding method, a carbon dioxide-rich gas mixture with at least 50 mol %, preferably at least 85 mol % or more carbon dioxide can be produced that can be used directly in a corresponding method for enhanced oil recovery and advantageously does not require any complex subsequent purification.

Advantageously, within the framework of the proposed method, the hydrocarbon-containing fuel is natural gas and/or gasoline. The choice of the respective hydrocarbon-containing fuel can be flexibly adapted to the fuels that are available at the site of use of a corresponding system.

The use of natural gas, which always contains methane as a main component, is especially advantageous. The methane portion of natural gas can be between 75 and 99 mol %. So-called “wet” natural gases in addition also contain larger portions (compare to non-wet natural gases) of higher hydrocarbons, for example ethane, propane, butane and ethene. Other secondary components of natural gas can be water, hydrogen sulfide, nitrogen and carbon dioxide. Depending on the required purity, a corresponding natural gas may be treated before combustion (for example, removal of water by condensation and gas-liquid separation, removal of hydrogen sulfide by scrubbing) It is not necessary to remove the CO2 and nitrogen from the natural gas. The contents of secondary components, especially inert gases such as nitrogen, must be considered in its use and contribute to the gas atmosphere that is forming in the engine.

An apparatus according to the invention comprises a gas engine for combustion of a hydrocarbon-containing fuel in a combustion chamber. The apparatus also comprises a fuel system for preparing the fuel, a fresh gas treatment system for enriching a fresh gas used in combustion with oxygen, and an exhaust gas system for treating the exhaust gas of the internal combustion engine and/or for returning at least part of the exhaust gas to the combustion chamber.

The fresh gas treatment system is for oxygen enrichment (or for corresponding depletion of nitrogen) of the fresh gas used for combustion of the fuel. For example, the fresh gas treatment system may comprise a (cryogenic) air separation system, a membrane separation unit, an absorber based system and/or a pressure swing adsorption unit. Corresponding cryogenic air separation systems have been known for a long time and have been set up especially for large volumetric throughputs. Membrane absorbers and pressure change adsorption units have energy advantages over them.

Advantageously, the fresh gas treatment system can be combined with a corresponding system, comprising a compressor and/or a turbocharger, for returning part of the exhaust gas to the combustion chamber. In this way, for example, cooling and/or ram-charging of the combustion chamber can be achieved.

The exhaust gas system advantageously has an exhaust gas treatment unit, a direct contact condenser and/or a gas purification unit by which the exhaust gas and a carbon dioxide-rich fraction obtained therefrom can be treated according to the respective purity requirements.

Advantageously, there is a unit for separating sulfur oxides as part of the exhaust gas treatment unit. To remove sulfur oxides, various methods are known from the prior art. They include, for example, washing with calcium oxide or neutralization with sodium alkali in a scrubbing column.

The exhaust gas system can also comprises a gas purification unit (e.g., a membrane separation unit or system based on absorbtion), positioned, for example, downstream from the exhaust gas treatment unit for separating oxygen and/or nitrogen oxides in a manner that is known in the art.

A method that is provided likewise according to the invention for enhanced oil recovery comprises the production of a carbon dioxide-rich gas mixture as explained above combined with the introduction of the carbon dioxide-rich gas mixture into a petroleum deposit and subsequent extraction of the mixture of petroleum and carbon dioxide formed by the introduction of the carbon dioxide-rich gas mixture. The method benefits from the advantages of the above-explained method and the corresponding apparatus, especially the efficient and flexible preparation of the carbon dioxide-rich gas mixture by the gas engine. A corresponding method can also be used in the enhanced extraction of mine gases and/or oil sands or shales.

In a corresponding apparatus for enhanced oil recovery, an above-explained apparatus for producing a carbon dioxide-rich gas mixture is used that is coupled to a system for introducing the carbon dioxide-rich gas mixture into the petroleum deposit.

Likewise, the invention encompasses the use of a gas engine in the corresponding methods and apparatuses, as were explained above.

### BRIEF DESCRIPTION OF THE DRAWINGS

Various other features and attendant advantages of the present invention will be more fully appreciated as the same becomes better understood when considered in conjunction with the accompanying drawing wherein:

FIG. 1 shows an apparatus for producing a carbon dioxide-rich gas mixture according to one especially preferred embodiment of the invention;

FIG. 2 shows an apparatus for producing a carbon dioxide-rich gas mixture according to another especially preferred embodiment of the invention; and

FIG. 3 shows an apparatus for producing a carbon dioxide-rich gas mixture according to a further especially preferred embodiment of the invention.

In the figures, the same elements are indicated with identical reference numbers. For the sake of clarity, a repeated explanation is omitted.

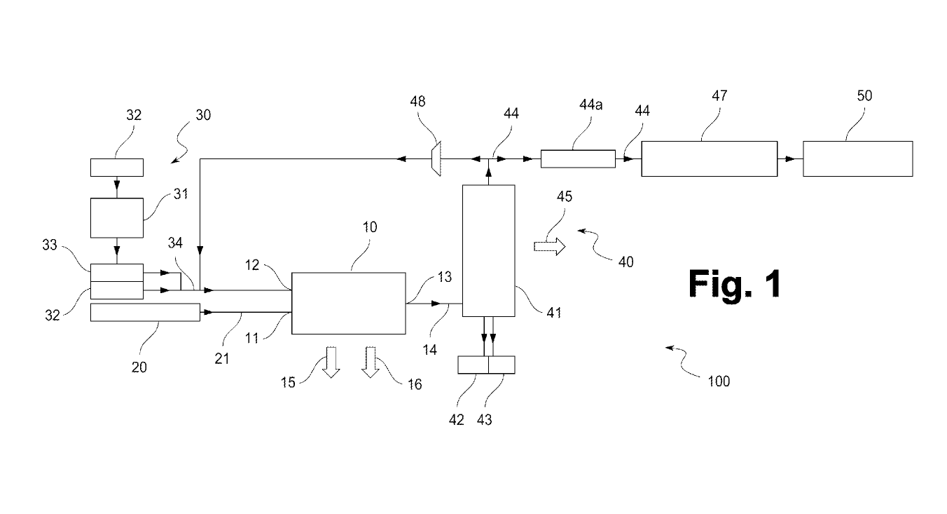

FIG. 1 shows an apparatus for producing a carbon dioxide-rich gas mixture, which apparatus is labeled 100 throughout.

The apparatus comprises a gas engine 10. The gas engine 10 has a fuel inlet 11 and a gas inlet 12. The fuel inlet 11 is coupled to a fuel system 20 by means of which fuel 21 can be prepared. The gas inlet 12 is connected to a fresh gas treatment system 30 that is explained below. The gas engine 10 furthermore has an exhaust gas outlet 13 via which exhaust gas 14 can be discharged. The engine generates power 15 and exhaust heat 16 that can be used advantageously within the framework of the method according to the invention, for example for operation of downstream systems or for injecting a corresponding gas mixture into a deposit. The simultaneous generation of power and heat therefore constitutes a further advantage.

The fresh gas treatment system 30 as explained above comprises, for example, an air separation system 31 (e.g., a (cryogenic) air separation system, a membrane separation unit, a system based on absorbtion and/or a pressure swing adsorption unit) that is set up to remove components of the feed air 32, i.e., for complete or partial enrichment of oxygen 33. The fresh gas treatment system 30 produces a fresh gas 34 for introduction into the combustion chamber of the gas engine 10. The fresh gas 34 can be optionally adapted according to the respective requirements by combining the fresh gas 34 with air 32 and/or oxygen 33.

The exhaust gas system 40 comprises an exhaust gas treatment unit 41. The exhaust gas treatment unit 41 advantageously has units for treating the exhaust gas such as units for cooling the exhaust gas 14, and/or for precipitation of water, and/or for filtration, and/or removal of sulfur oxides and the like. Waste 42 and water 43 are separated and exhaust heat 45 is dissipated via the exhaust gas treatment unit 41. A carbon dioxide-rich gas mixture 44 leaves the exhaust gas treatment unit 41 and travels, optionally via an interposed unit 44a that can be used, for example, for intermediate storage or further treatment, for example, into a gas purification unit 47 in which the correspondingly treated gas mixture 44 is further purified, i.e., unwanted components such as oxygen, nitrogen oxides, etc., are removed (for example, by catalytic oxidation combined with adsorption). Furthermore, in the gas purification unit 47, for example, the gas mixture 44 can be compressed (e.g., in a compressor) and dried (e.g., in glycol drying unit or in an adsorber). The gas mixture 44 is afterwards available for an application 50, for example for enhanced oil recovery and/or for corresponding storage. A compressor 48 is provided that is connected to a corresponding line of the exhaust gas system 40 and by means of which one part of the exhaust gas 14 or of the carbon dioxide-rich gas mixture 44 can be supplied back (recycled) to the gas engine 10.

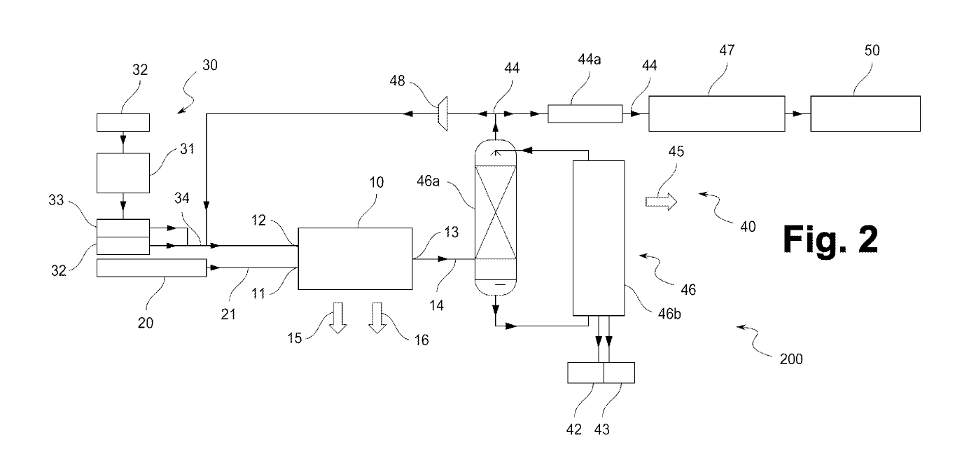

FIG. 2 shows another apparatus for producing a carbon dioxide-rich gas mixture according to one especially preferred embodiment of the invention that is labeled 200 throughout.

The apparatus has available the important components of the above-explained apparatus 100. The exhaust gas treatment unit is made here as a direct contact condenser 46 that comprises a cooling column 46a and a corresponding water treatment system 46b. The exhaust gas can be cooled accordingly via the direct contact condenser 46. Water and, for example, sulfur oxides can be precipitated optionally via adding corresponding additives to the cooling water. The exhaust gas 14 that has been treated accordingly to form a carbon dioxide-rich gas 44 as explained above is supplied to a gas purification unit 47 and subsequently to a corresponding application. Using this system, a carbon dioxide-rich gas with a carbon dioxide content of more than 50% can be achieved.

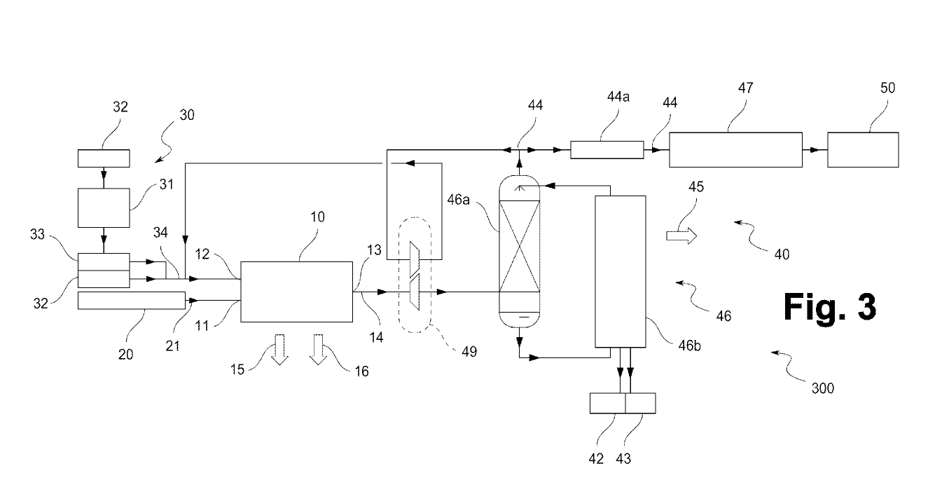

FIG. 3 shows an apparatus for producing a carbon dioxide-rich gas mixture according to another preferred embodiment of the invention and is labeled 300 throughout. The apparatus 300 comprises the important elements of the apparatus 200. The apparatus 300 has a turbocharger 49 that is set up for supercharging the gas engine 10 with pressurized exhaust gas 14.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German application German Application No. 10 2011 108 854.0, filed Jul. 28, 2011, are incorporated by reference herein.

### REFERENCE NUMBER LIST

10 Gas engine
11 Fuel inlet
12 Gas inlet
13 Exhaust gas outlet
14 Exhaust gas
15 Power
16 Exhaust heat
20 Fuel system
21 Fuel
30 Fresh gas treatment system
31 Air separation unit
32 Air
33 Oxygen
34 Fresh gas
40 Exhaust gas system
41 Exhaust gas treatment unit
42 Waste
43 Water
44 Carbon dioxide-rich gas mixture
45 Exhaust heat
46 Direct contact condenser
46a Cooling column
46b Water treatment system
47 Gas purification unit
48 Compressor
49 Turbocharger
50 Application
100, 200, 300 Apparatus for producing a carbon dioxide-rich gas mixture

1. A method for producing a carbon dioxide-rich gas mixture (44), comprising:
combusting a hydrocarbon-containing fuel (21) in a combustion chamber of a gas engine (10) in a gas atmosphere, and
processing an exhaust gas (14) from the gas engine (10) into a carbon dioxide-rich gas mixture (44),
wherein the gas atmosphere introduced into the combustion chamber of the gas engine has an oxygen content which is 0.9 to 1.1 times the amount of oxygen required for complete combustion of the hydrocarbon-containing fuel (21), and wherein the volumetric ratio of nitrogen to oxygen (33) in the gas atmosphere is less than 3.5 to 1.

2. The method according to claim 1, wherein the volumetric ratio of nitrogen to oxygen (33) in the gas atmosphere is less than 3 to 1.

3. The method according to claim 1, wherein the volumetric ratio of nitrogen to oxygen (33) in the gas atmosphere is less than 2 to 1.

4. The method according to claim 1, wherein the volumetric ratio of nitrogen to oxygen (33) in the gas atmosphere is less than 1 to 1.

5. The method according to claim 1, wherein the volumetric ratio of nitrogen to oxygen (33) in the gas atmosphere is less than 1 to 2.

6. The method according to claim 1, wherein the volumetric ratio of nitrogen to oxygen (33) in the gas atmosphere is less than 1 to 3.

7. The method according to claim 1, wherein the volumetric ratio of nitrogen to oxygen (33) in the gas atmosphere is less than 1 to 4.

8. The method according to claim 1, said gas atmosphere comprises part of the exhaust gas (14) which is recycled to the combustion chamber.

9. The method according claim 1, wherein processing of the exhaust gas (14) comprises cooling, precipitation of water, filtration and/or separation of unwanted components.

10. The method according to claim 1, wherein a carbon dioxide-rich gas mixture (44) contains at least 50 mol % of carbon dioxide.

11. The method according to claim 1, wherein natural gas and/or gasoline is used as the hydrocarbon-containing fuel (21).

12. An apparatus (100, 200, 300) for producing a carbon dioxide-rich gas mixture (44), comprising:
an internal combustion engine (10) for combustion of a hydrocarbon-containing fuel (21) in a combustion chamber, a fuel system (20) for preparation of fuel (21) introduced into said combustion chamber, a fresh gas treatment system (20) for enriching a fresh gas with oxygen for introduction into said combustion chamber, and an exhaust gas system (40) for treating the exhaust gas (14) from said internal combustion engine and optionally returning a part of the exhaust gas (14) to said combustion chamber.

13. The apparatus (100, 200, 300) according to claim 12, wherein said fresh gas treatment system (20) for enriching the fresh gas with oxygen comprises an air separation system (31), a membrane absorber and/or a pressure-change adsorption unit.

14. The apparatus (100, 200, 300) according to claim 12, wherein said exhaust gas system (40) comprises a compressor (48) and/or a turbocharger (49).

15. The apparatus (100, 200, 300) according to claim 12, wherein said exhaust gas system (40) has an exhaust gas treatment unit (41), a direct contact condenser (46) and/or a gas purification unit (47).

16. The apparatus (100, 200, 300) according to claim 15, wherein said exhaust gas treatment unit (41) has a unit for separation of sulfur oxides.

17. The apparatus (100, 200, 300) according to claim 15, wherein said gas purification unit (47) has a unit for separation of oxygen and/or nitrogen oxides.

18. A method for enhanced oil recovery comprising:
producing a carbon dioxide-rich gas mixture (44) by means of a method according to claim 1,
introducing said carbon dioxide-rich gas mixture (44) into a petroleum deposit, and
extracting a mixture of petroleum and carbon dioxide formed by the introduction of said carbon dioxide-rich gas mixture (44) into said deposit.

19. An apparatus for enhanced oil recovery comprising
an apparatus according to claim 12, and
a system for introducing the carbon dioxide-rich gas mixture (44) into a petroleum deposit.
